(19) United States
(12) Patent Application Publication
(10) Pub. No.: US 2026/0144276 A1
(43) Pub. Date: May 28, 2026

(54) METHOD FOR REDUCING BEANY FLAVOR OF TEXTURED VEGETABLE PROTEIN CONTAINING SOY PROTEIN

(71) Applicant: DAESANG CORPORATION, Seoul (KR)

(72) Inventors: Bo-Ra KIM, Goyang-si, Gyeonggi-do (KR); Ji-Eun HWANG, Seoul (KR); Jin-Young JEON, Seongnam-si, Gyeonggi-do (KR)

(73) Assignee: DAESANG CORPORATION, Seoul (KR)

(21) Appl. No.: 19/123,305

(22) PCT Filed: Oct. 18, 2023
(86) PCT No.: PCT/KR2023/016090

§ 371 Date: Apr. 22, 2025

(30) Foreign Application Priority Data
Oct. 25, 2022 (KR) 10-2022-0138396

(51) Int. Cl. A23J 3/26; A23J 3/16; A23J 3/18; A23J 3/20; A23J 3/22

(52) U.S. Cl. CPC A23J 3/26; A23J 3/16; A23J 3/18; A23J 3/20; A23J 3/22

(57) ABSTRACT

Provided are a method for reducing the beany flavor of a textured vegetable protein containing soy protein, the method of which comprises using Chlorella, and a method for preparing a textured vegetable protein with reduced beany flavor, the method of which comprises using Chlorella.

### TECHNICAL FIELD

The present invention relates to a method for reducing the beany flavor of a textured vegetable protein containing soy protein. And, the present invention relates to a method for preparing a textured vegetable protein with reduced beany flavor.

### BACKGROUND ART

A textured vegetable protein (TVP) is being used as a material for producing a meat substitute. The textured vegetable protein is a vegetable soy protein having texture similar to the texture of meat by inducing physical changes thereof and is referred to as ‘textured soy protein’, ‘artificial meat’, and the like. Recently, it has taste and texture almost similar to exiting meat and thus is also referred to as ‘plant protein-based meat analog’. In addition, it is also referred to as various names such as ‘plant-based meat’, ‘meat substitute or meat alternative’, ‘meat analogue’, and ‘vegetarian meat’.

A textured vegetable protein is prepared by extrusion-forming soy proteins such as concentrated soy protein (CSP) and isolated soy protein (ISP) as main materials, along with additives such as salt and gluten. The ‘extrusion-forming’ is a high-temperature, short-term process technology that can extrude vegetable protein into a fibrous tissue with a meat-like texture in a short period of time by applying heat, pressure, and shear force to the inside of an extruder barrel. Depending on the structure of the extrusion port and the moisture content of the product, textured vegetable proteins may be classified into a high moisture extrusion (HME) textured vegetable protein and a low moisture extrusion (LME) textured vegetable protein.

However, textured vegetable proteins containing soy protein, such as concentrated soy protein or isolated soy protein, have the problem of lowering consumer preference due to characteristic off-flavors of soybeans, such as green smell or beany flavor.

### DISCLOSURE

### Technical Problem

The present inventors have carried out various studies to develop a method capable of reducing the beany flavor of a textured vegetable protein containing soy protein. As a result, the present inventors have found that, when Chlorella is mixed with soy protein and then an extrusion process was performed, a textured vegetable protein with significantly reduced beany flavor is obtained. That is, the present inventors have found that Chlorella acts as a beany flavor-reducing agent capable of reducing the beany flavor of textured vegetable proteins containing soy protein.

Therefore, it is an object of the present invention to provide a method for reducing the beany flavor of a textured vegetable protein containing soy protein, comprising using Chlorella.

It is another object of the present invention to provide a method for preparing a textured vegetable protein with reduced beany flavor, comprising using Chlorella.

### Technical Solution

In accordance with an aspect of the present invention, there is provided a method for reducing the beany flavor of a textured vegetable protein containing soy protein, the method of which comprises extruding a mixture comprising Chlorella and soy protein to form a textured vegetable protein.

In accordance with another aspect of the present invention, there is provided a method for preparing a textured vegetable protein with reduced beany flavor, the method of which comprises extruding a mixture comprising Chlorella and soy protein to form a textured vegetable protein.

### Advantageous Effects

It is found by the present invention that, when Chlorella is mixed with soy protein and then an extrusion process was performed, a textured vegetable protein with significantly reduced beany flavor is obtained. That is, it is found by the present invention that Chlorella acts as a beany flavor-reducing agent capable of reducing the beany flavor of textured vegetable proteins containing soy protein. Therefore, the method according to the present invention can be usefully used to reduce the beany flavor of textured vegetable proteins containing soy protein and can also be usefully used to prepare textured vegetable proteins with reduced beany flavor.

### DESCRIPTION OF DRAWINGS

FIG. 1 shows the appearance of the high moisture extrusion (HME) textured vegetable protein prepared according to Comparative Example 1.

FIG. 2 shows the appearance of the high moisture extrusion (HME) textured vegetable protein prepared according to Example 1-1.

FIG. 3 shows the appearance of the high moisture extrusion (HME) textured vegetable protein prepared according to Example 1-2.

FIG. 4 shows the appearance of the high moisture extrusion (HME) textured vegetable protein prepared according to Example 1-3.

FIG. 5 shows the appearance of the high moisture extrusion (HME) textured vegetable protein prepared according to Example 1-4.

FIG. 6 shows the appearance of the high moisture extrusion (HME) textured vegetable protein prepared according to Example 1-5.

FIG. 7 shows the appearance of the high moisture extrusion (HME) textured vegetable protein prepared according to Comparative Example 2.

FIG. 8 shows the appearance of the high moisture extrusion (HME) textured vegetable protein prepared according to Example 2-1.

FIG. 9 shows the appearance of the high moisture extrusion (HME) textured vegetable protein prepared according to Example 2-2.

FIG. 10 shows the appearance of the high moisture extrusion (HME) textured vegetable protein prepared according to Example 2-3.

### BEST MODE

The present invention provides a method for reducing the beany flavor of a textured vegetable protein containing soy protein, the method of which comprises extruding a mixture comprising Chlorella and soy protein to form a textured vegetable protein.

And, the present invention provides a method for preparing a textured vegetable protein with reduced beany flavor, the method of which comprises extruding a mixture comprising Chlorella and soy protein to form a textured vegetable protein.

The Chlorella may be a powder obtained by drying a biomass obtained through culturing a Chlorella strain. The Chlorella strain includes, without limitation, a known genus Chlorella strain, for example, Chlorella protothecoides, Chlorella vulgaris, Chlorella sorokiniana, or Chlorella pyrenoidosa.

For example, the Chlorella strain may be Chlorella vulgaris DSV77 (KCTC 11383BP) disclosed in Korean Patent No. 10-1106198, and the like.

For example, the Chlorella strain may be a chlorophyll-deficient Chlorella strain. That is, the Chlorella may be a powder obtained by drying a biomass obtained through culturing a chlorophyll-deficient Chlorella strain. The chlorophyll-deficient Chlorella strain may be a known genus Chlorella strain, for example, a Chlorella protothecoides species, which is cultured in a yellow colony form. Preferably, the chlorophyll-deficient Chlorella strain may be a Chlorella protothecoides species obtained through heterotrophic culture, with a sugar, in the absence of light. In an embodiment, the chlorophyll-deficient Chlorella strain may be a strain obtained through heterotrophic culture of Chlorella protothecoides DS-NCRC7 (KCTC 18633P) (Korean Patent No. 10-2026681) having high crude-protein productivity which was developed by the present inventors, with a sugar, in the absence of light. The culture may be carried out according to conventional culture methods of a Chlorella strain, e.g., the culture methods disclosed in Korean Patent No. 10-2026681. For example, the culture may be carried out in a medium containing glucose as a sugar source, phosphates (KH₂PO₄, K₂HPO₄, etc.), metal salts (MgSO₄, ZnSO₄, CuSO₄, FeSO₄, NaMoO₄, MnCl₂, etc.), boric acid, etc., in water (e.g., purified water, etc.). And, if necessary, the medium may further include an antifoaming agent or the like. The culture in the medium described above may be carried out according to conventional culture methods, for example, according to aseptic and heterotrophic fed-batch culture (e.g., using glucose as a sugar source) in a sterile tank, under 0.3-1.0 vvm of air, 200-500 rpm of agitation, and pH 6.5-7.5.

For example, the Chlorella strain may be a white Chlorella protothecoides strain. Preferably, the Chlorella strain may be a white Chlorella protothecoides strain having a high crude protein content developed by the present inventors (Korean Patent Application No. 10-2023-0022628, filed on Feb. 21, 2023). The Korean Patent Application No. 10-2023-0022628 is incorporated herein by reference in its entirety. In one embodiment, the Chlorella may be a powder obtained by drying a biomass obtained through culturing a Chlorella protothecoides strain, having a whiteness index (WI) of 70 or more as calculated from the following formula and a crude protein content of 55 wt % or more in the biomass.

$$WI = 100 - \sqrt{{( 100 - L )}^{2} + {a}^{2} + {b}^{2}}$$

wherein, L, a, and b are Hunter L, a, and b values.

A crude protein content in the biomass may be 55 to 80 wt %, and the chlorophyll content in the biomass may be 3.0 or less mg/g dry cell wight (DCW), for example, 0.1 to 3.0 mg/g dry cell wight. In an embodiment, the strain may be Chlorella protothecoides DS-NCRC7W) (KCTC 15163BP). The culture may be carried out according to conventional culture methods of a Chlorella strain, e.g., the culture methods disclosed in Korean Patent No. 10-2026681. For example, the culture may be carried out in a medium containing glucose as a sugar source, phosphates (KH₂PO₄, K₂HPO₄, etc.), ammonium salts ((NH₄)₂SO₄, etc.), calcium salts (CaCl₂), etc.), metal salts (MgSO₄, ZnSO₄, CuSO₄, FeSO₄, etc.), etc., in water (e.g., purified water, etc.). In an embodiment, the culture may be carried out in an aqueous medium having a pH of 6.5 to 7.5, containing 2-15 g/L of MgSO₄, 0.5-5 g/L of KH₂PO₄, 0.0001-0.1 g/L of ZnSO₄, 0.0001-0.01 g/L of CuSO₄, 0.001-0.1 g/L of CaCl₂), and 0.001-0.1 g/L of FeSO₄. And, if necessary, the medium may further include an antifoaming agent or the like. The culture in the medium described above may be carried out according to conventional culture methods, for example, according to fed-batch culture in a sterile tank, under 0.3-1.0 vvm of air and 200-500 rpm of agitation.

The powder obtained by drying the biomass obtained by culturing the above Chlorella strain (also referred to herein as ‘Chlorella raw material’ or ‘Chlorella powder’) can be obtained, for example, by culturing a Chlorella strain, recovering a biomass according to a conventional method, and then performing a drying process such as spray drying. For example, it may be prepared by recovering a biomass, e.g., through centrifuging a culture solution of a Chlorella strain and then drying with a conventional method such as spray drying, if necessary. The Chlorella may comprise a microalgae protein of 45 wt % or more based on dry weight. And, the Chlorella may have a lipid content of preferably 30 wt % or less, more preferably 20 wt % or less, still more preferably 5 to 15 wt %, and particularly preferably 6 to 10 wt %, based on dry weight.

In the method of the present invention, the amount of the Chlorella may be 0.1 to 31 wt %, preferably 3 to 16 wt %, based on the total weight of the mixture.

In the method of the present invention, the soy protein may be used in an amount sufficient to obtain a desired textured vegetable protein. For example, the amount of the soy protein may be 10 to 36 wt %, preferably 11 to 34 wt %, based on the total weight of the mixture.

In the method of the present invention, the mixture may further comprise 35 to 65 wt %, preferably 45 to 60 wt %, of water. In an embodiment, the mixture may comprise 10 to 36 wt % of soy protein, 0.1 to 31 wt % of Chlorella, and 35 to 65 wt % of water.

In the method of the present invention, the mixture may also further comprise gluten, oil, or a mixture thereof. In an embodiment, the mixture may further comprise 0 to 10 wt % of gluten and 1 to 1.5 wt % of oil. In another embodiment, the mixture may comprise 10 to 36 wt % of soy protein, 0.1 to 31 wt % of Chlorella, 0 to 10 wt % of gluten, 1 to 1.5 wt % of oil, and 35 to 65 wt % of water.

In the method of the present invention, the extruding may be performed by a method conventionally used for forming textured vegetable proteins. For example, extruding is carried out at an ejection temperature of 80 to 170° C. and a cooling temperature (e.g., the temperature of a cooling die) of 68 to 75° C., in a twin-screw extruder. However, those skilled in the art will appreciate that a variety of extrusion conditions may be employed.

The present invention will be described in further detail with reference to the following examples. These examples are for illustrative purposes only and are not intended to limit the scope of the present invention.

### Example 1: Preparation and Evaluation of Textured Vegetable Proteins Containing Chlorella

### (1) Chlorella Powder

According to the method disclosed in Korean Patent No. 10-2026681, Chlorella protothecoides DS-NCRC7 (KCTC 18633P) was mass-cultured in a 240K [symbol] Jar fermenter, followed by centrifuging to recover the biomass, which was then spray-dried to obtain a powder. The resulting powder was used as a ‘Chlorella powder’ in Example 1 below. As a result of analysis of the ‘Chlorella powder’, it contained about 7 wt % of lipid and about 60 wt % microalgae protein, based on dry weight.

### (2) Preparation of Textured Vegetable Proteins

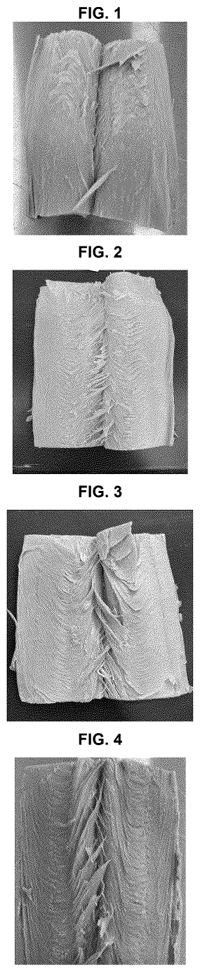

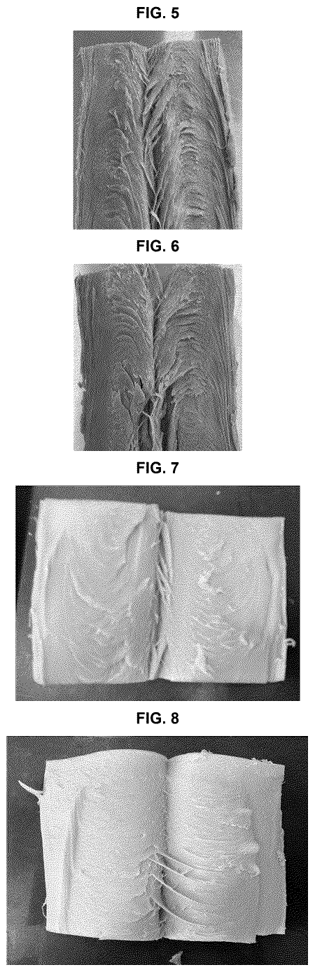

Textured vegetable proteins were prepared according to the components and amounts of the following Table 1. The content of each component in Table 1 means % by weight. Specifically, soy protein concentrate (Arcon™ SM, ADM (Archer Daniels Midland), protein content of 75%), the Chlorella powder, salt, gluten (Examples 1-3 to 1-5), oil, and purified water were mixed. Each resulting mixture was extruded using a twin-screw extruder (Twin-Screw PiloTwin™, Buhler) with five barrels set to different ejection temperatures of about 90 to 168° C. and a cooling die temperature of about 70° C. to produce high moisture (HME) textured vegetable proteins. FIGS. 1 to 6 show the appearances of the high moisture (HME) textured vegetable proteins prepared according to Comparative Example 1 and Examples 1-1 to 1-5, respectively.

TABLE 1

| | | Example | | | | |
|---|---|---|---|---|---|---|
| | Comparative | Example | Example | Example | Example | Example |
| | Example 1 | 1-1 | 1-2 | 1-3 | 1-4 | 1-5 |
| Soy protein | 37 | 33 | 29.3 | 18.9 | 15.4 | 11.4 |
| concentrate | | | | | | |
| Chlorella | — | 10 | 15.7 | 20.0 | 25.0 | 31.2 |
| powder | | | | | | |
| Salt | 1.0 | 1.0 | 1.0 | 1.0 | 1.0 | 1.0 |
| Gluten | — | — | — | 7.1 | 7.6 | 9.4 |
| Oil | 1.5 | 1.5 | 1.5 | 1.5 | 1.5 | 1.5 |
| Purified | 60.5 | 54.5 | 52.5 | 51.5 | 49.5 | 45.5 |
| water | | | | | | |

### (3) Solid Phase Micro Extraction (SPME) Analysis (1)

The textured vegetable proteins prepared in Comparative Example 1 and Examples 1-1 and 1-2 were pulverized at an ultra-low temperature using a freeze grinder. After 2 g of the freeze-pulverized sample and 4 μL of 1,2,3-trichloropropane (500 ppm, internal standard) were mixed in an SPME amber vial, an SPME fiber (65 μm PDMS/DVB, Supelco) was inserted into the top of the vial for 40 minutes to allow volatile substances to be adsorbed.

The amounts of 2-heptanone and 2-pentylfuran were analyzed as beany flavor indicators. For the analysis of said compounds, a GC-MS/MS system from Thermo Scientific and a DB-Wax (60 m×0.25 mm, 0.50 micron) column were used. The analysis was performed in Split mode by inserting the SPME inlet liner (4 mm i.d., Agilent) into the GC injector. The temperature of the GC oven was maintained at 40° C. for 5 minutes, then increased at 4° C./min to 200° C., and maintained at 200° C. for 10 minutes. The temperatures of the injector and the detector were set to 230° C. and 250° C., respectively. Each compound was identified with the NIST Mass Spectral Search Program. The results are shown in the following Table 2.

TABLE 2

| | 2-Heptanone | | 2-Pentylfuran | |
|---|---|---|---|---|
| | Relative | Relative | Relative | Relative |
| | peak ratio | percentage | peak ratio | percentage |
| Comparative | 0.54 ± 0.03 | 100 | 2.85 ± 0.14 | 100 |
| Example 1 | | | | |
| Example 1-1 | 0.45 ± 0.02 | 82 | 2.69 ± 0.08 | 94 |
| Example 1-2 | 0.40 ± 0.01 | 73 | 2.51 ± 0.01 | 88 |

From the results in Table 2 above, it can be confirmed that the relative values of 2-heptanone and 2-pentylfuran, which are representative beany flavor indicators, are reduced when Chlorella was mixed in.

### (4) Solid Phase Micro Extraction (SPME) Analysis (2)

According to the components and amounts of the following Table 3, soy protein concentrate (Arcon™ SM, ADM (Archer Daniels Midland), protein content of 75%) and the Chlorella powder were mixed to prepare a dispersion containing soy protein concentrate at a concentration of 5% (w/w). The content of each component in Table 3 means % by weight. After the resulting dispersions were heated at 90° C. for 15 minutes, the amounts of 2-heptanone and 2-pentylfuran, which are beany flavor indicators, were analyzed via GC-MS/MS according to the same methods as in (3) above. The results are shown in Table 4.

TABLE 3

| | Disper- | Disper- | Disper- | Disper- |
|---|---|---|---|---|
| | sion 1-1 | sion 1-2 | sion 1-3 | sion 1-4 |
| Soy protein | 5.0 | 5.0 | 5.0 | 5.0 |
| concentrate | | | | |
| Chlorella powder | — | 1.25 | 2.5 | 5.0 |
| Purified water | 95.0 | 93.75 | 92.5 | 90.0 |

TABLE 4

| | 2-Heptanone | | 2-Pentylfuran | |
|---|---|---|---|---|
| | Relative | Relative | Relative | Relative |
| | peak ratio | percentage | peak ratio | percentage |
| Dispersion 1-1 | 0.038 ± 0.003 | 100 | 0.139 ± 0.008 | 100 |
| Dispersion 1-2 | 0.029 ± 0.002 | 77 | 0.051 ± 0.001 | 37 |
| Dispersion 1-3 | 0.027 ± 0.002 | 69 | 0.039 ± 0.002 | 28 |
| Dispersion 1-4 | 0.031 ± 0.003 | 81 | 0.020 ± 0.000 | 15 |

From the results in Table 4 above, it can be confirmed that the relative values of 2-heptanone and 2-pentylfuran, which are representative beany flavor indicators, are reduced when Chlorella is mixed in. Especially, it can be confirmed that the content of 2-pentylfuran can be reduced by more than half.

### Example 2: Preparation and Evaluation of Textured Vegetable Proteins Containing Chlorella

### (1) Chlorella Powder

According to the method disclosed in Korean Patent Application No. 10-2023-0022628 filed on Feb. 21, 2023, Chlorella protothecoides DS-NCRC7W) (KCTC 15163BP) was mass-cultured in a 240K [symbol] Jar fermenter, followed by centrifuging to recover the biomass, which was then spray-dried to obtain a powder. The resulting powder was used as a ‘Chlorella powder’ in Example 2 below. As a result of analysis of the ‘Chlorella powder’, it contained about 11 wt % of lipid and about 60 wt % of microalgae protein, based on dry weight.

### (2) Preparation of Textured Vegetable Proteins

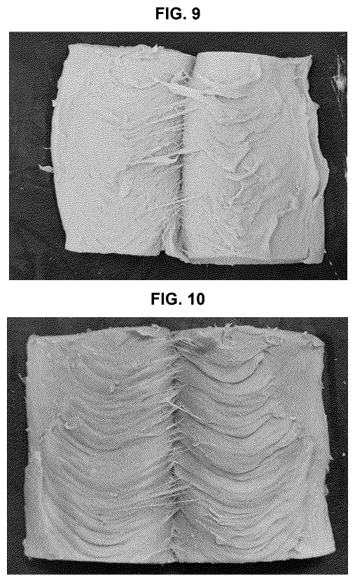

Textured vegetable proteins were prepared according to the components and amounts of the following Table 5. The content of each component in Table 5 means % by weight. Specifically, soy protein concentrate (Arcon™ SM, ADM (Archer Daniels Midland), protein content of 75%), the Chlorella powder, gluten (Example 2-3), oil, and purified water were mixed. Each resulting mixture was extruded using a twin-screw extruder (Twin-Screw PiloTwin™, Buhler) with five barrels set to different ejection temperatures of about 90 to 168° C. and a cooling die temperature of about 70° C. to produce high moisture (HME) textured vegetable proteins. FIGS. 7 to 10 show the appearances of the high moisture (HME) textured vegetable proteins prepared according to Comparative Example 2 and Examples 2-1 to 2-3, respectively.

TABLE 5

| | | Example | | |
|---|---|---|---|---|
| | Comparative | Exam- | Exam- | Exam- |
| | Example 2 | ple 2-1 | ple 2-2 | ple 2-3 |
| Soy protein | 37 | 32 | 31 | 25 |
| concentrate | | | | |
| Chlorella powder | — | 5 | 10 | 15 |
| Gluten | — | — | — | 5 |
| Oil | 1.5 | 1.5 | 1.5 | 1.5 |
| Purified water | 61.5 | 61.5 | 57.5 | 53.5 |

### (3) Solid Phase Micro Extraction (SPME) Analysis (1)

For the textured vegetable proteins prepared in Comparative Example 2 and Examples 2-1 to 2-3, the amounts of 2-heptanone, 2-pentylfuran, and 1-octen-3-ol, which are beany flavor indicators, were analyzed using the same method as in (3) of Example 1. The results are shown in Table 6 below.

TABLE 6

| | 2-Heptanone | | 2-Pentylfuran | | 1-Octen-3-ol | |
|---|---|---|---|---|---|---|
| | Relative | Relative | Relative | Relative | Relative | Relative |
| | peak ratio | percentage | peak ratio | percentage | peak ratio | percentage |
| Comparative | 0.568 ± 0.007 | 100 | 4.630 ± 0.173 | 100 | 0.717 ± 0.004 | 100 |
| Example 2 | | | | | | |
| Example 2-1 | 0.518 ± 0.023 | 91 | 4.164 ± 0.175 | 90 | 0.714 ± 0.047 | 100 |
| Example 2-2 | 0.485 ± 0.007 | 85 | 4.239 ± 0.131 | 92 | 0.650 ± 0.013 | 91 |
| Example 2-3 | 0.444 ± 0.021 | 78 | 3.669 ± 0.262 | 79 | 0.569 ± 0.023 | 79 |

From the results in Table 6 above, it can be confirmed that the relative values of 2-heptanone, 2-pentylfuran, and 1-octen-3-ol, which are representative beany flavor indicators, are reduced when Chlorella was mixed in.

### (4) Solid Phase Micro Extraction (SPME) Analysis (2)

According to the components and amounts of the following Table 7, soy protein concentrate (Arcon™ SM, ADM (Archer Daniels Midland), protein content of 75%) and the Chlorella powder were mixed to prepare a dispersion containing soy protein concentrate at a concentration of 5% (w/w). The content of each component in Table 7 means % by weight. After the resulting dispersions were heated at 90° C. for 15 minutes, the amounts of 2-heptanone, 2-pentylfuran, and 3,5-(E,E)-octadien-2-one, which are beany flavor indicators, were analyzed via GO-MS/MS according to the same methods as in (3) of Example 1. The results are shown in Table 8.

TABLE 7

| | Disper- | Disper- | Disper- | Disper- |
|---|---|---|---|---|
| | sion 2-1 | sion 2-2 | sion 2-3 | sion 2-4 |
| Soy protein | 5.0 | 5.0 | 5.0 | 5.0 |
| concentrate | | | | |
| Chlorella powder | — | 1.25 | 2.5 | 5.0 |
| Purified water | 95.0 | 93.75 | 92.5 | 90.0 |

TABLE 8

| | 2-Heptanone | | 2-Pentylfuran | | 3,5-(E,E)-Octadien-2-one | |
|---|---|---|---|---|---|---|
| | Relative | Relative | Relative | Relative | Relative | Relative |
| | peak ratio | percentage | peak ratio | percentage | peak ratio | percentage |
| Dispersion | 0.088 ± 0.001 | 100 | 0.152 ± 0.006 | 100 | 0.160 ± 0.004 | 100 |
| 2-1 | | | | | | |
| Dispersion | 0.055 ± 0.001 | 62 | 0.074 ± 0.008 | 49 | 0.051 ± 0.000 | 32 |
| 2-2 | | | | | | |
| Dispersion | 0.044 ± 0.000 | 49 | 0.055 ± 0.004 | 36 | 0.027 ± 0.000 | 17 |
| 2-3 | | | | | | |
| Dispersion | 0.036 ± 0.002 | 41 | 0.048 ± 0.001 | 32 | 0.022 ± 0.000 | 14 |
| 2-4 | | | | | | |

From the results in Table 8 above, it can be confirmed that the relative values of 2-heptanone, 2-pentylfuran, and 3,5-(E,E)-octadien-2-one, which are representative beany flavor indicators, are significantly reduced when Chlorella is mixed in.

### Example 3: Preparation and Evaluation of Soy Protein Concentrate-Containing Dispersions

The culture solution of Chlorella vulgaris DSV77 (KCTC 11383BP, Korean Patent No. 10-1106198) was centrifuged to recover the biomass, which was then spray-dried to obtain a ‘Chlorella powder CV’. According to the components and amounts of the following Table 9, soy protein concentrate (Arcon™ SM, ADM (Archer Daniels Midland), protein content of 75%) and the Chlorella powder CV were mixed to prepare a dispersion containing soy protein concentrate at a concentration of 5% (w/w). The content of each component in Table 9 means % by weight. After the resulting dispersions were heated at 90° C. for 15 minutes, the amounts of 1-octen-3-ol and 2-pentylfuran, which are beany flavor indicators, were analyzed via GC-MS/MS according to the same methods as in (3) of Example 1. The results are shown in Table 10.

TABLE 9

| | Disper- | Disper- | Disper- | Disper- |
|---|---|---|---|---|
| | sion 3-1 | sion 3-2 | sion 3-3 | sion 3-4 |
| Soy protein | 5.0 | 5.0 | 5.0 | 5.0 |
| concentrate | | | | |
| Chlorella | — | 1.25 | 2.5 | 5.0 |
| powder CV | | | | |
| Purified water | 95.0 | 93.75 | 92.5 | 90.0 |

TABLE 10

| | 1-Octen-3-ol | | 2-Pentylfuran | |
|---|---|---|---|---|
| | Relative | Relative | Relative | Relative |
| | peak ratio | percentage | peak ratio | percentage |
| Dispersion 3-1 | 0.138 ± 0.000 | 100 | 0.152 ± 0.006 | 100 |
| Dispersion 3-2 | 0.059 ± 0.003 | 43 | 0.018 ± 0.002 | 12 |
| Dispersion 3-3 | 0.047 ± 0.001 | 34 | 0.016 ± 0.000 | 11 |
| Dispersion 3-4 | 0.038 ± 0.001 | 28 | 0.015 ± 0.000 | 10 |

From the results in Table 10 above, it can be confirmed that the relative values of 1-octen-3-ol and 2-pentylfuran, which are representative beany flavor indicators, are significantly reduced when Chlorella is mixed in.

### Example 4: Preparation and Evaluation of Soy Protein Concentrate-Containing Dispersions

The culture solution of Chlorella sorokiniana (UTEX1230) was centrifuged to recover the biomass, which was then spray-dried to obtain a ‘Chlorella powder CS’. According to the components and amounts of the following Table 11, soy protein concentrate (Arcon™ SM, ADM (Archer Daniels Midland), protein content of 75%) and the Chlorella powder CS were mixed to prepare a dispersion containing soy protein concentrate at a concentration of 5% (w/w). The content of each component in Table 11 means % by weight. After the resulting dispersions were heated at 90° C. for 15 minutes, the amounts of 2-heptanone, 3,5-(E,E)-octadien-2-one, and benzaldehyde, which are beany flavor indicators, were analyzed via GC-MS/MS according to the same methods as in (3) of Example 1. The results are shown in Table 12.

TABLE 11

| | Disper- | Disper- | Disper- | Disper- |
|---|---|---|---|---|
| | sion 4-1 | sion 4-2 | sion 4-3 | sion 4-4 |
| Soy protein | 5.0 | 5.0 | 5.0 | 5.0 |
| concentrate | | | | |
| Chlorella | — | 1.25 | 2.5 | 5.0 |
| powder CS | | | | |
| Purified water | 95.0 | 93.75 | 92.5 | 90.0 |

TABLE 12

| | 2-Heptanone | | 3,5-(E,E)-Octadien-2-one | | Benzaldehyde | |
|---|---|---|---|---|---|---|
| | Relative | Relative | Relative | Relative | Relative | Relative |
| | peak ratio | percentage | peak ratio | percentage | peak ratio | percentage |
| Dispersion | 0.088 ± 0.001 | 100 | 0.160 ± 0.004 | 100 | 0.125 ± 0.002 | 100 |
| 4-1 | | | | | | |
| Dispersion | 0.009 ± 0.000 | 10 | 0.011 ± 0.000 | 7 | 0.042 ± 0.001 | 33 |
| 4-2 | | | | | | |
| Dispersion | 0.006 ± 0.000 | 7 | 0.006 ± 0.000 | 4 | 0.039 ± 0.001 | 31 |
| 4-3 | | | | | | |
| Dispersion | 0.006 ± 0.000 | 7 | 0.004 ± 0.000 | 2 | 0.037 ± 0.001 | 30 |
| 4-4 | | | | | | |

From the results in Table 12 above, it can be confirmed that the relative values of 2-heptanone, 3,5-(E,E)-octadien-2-one, and benzaldehyde, which are representative beany flavor indicators, are significantly reduced when Chlorella is mixed in.

1. A method for reducing the beany flavor of a textured vegetable protein containing soy protein, the method of which comprises extruding a mixture comprising Chlorella and soy protein to form a textured vegetable protein.

2. (canceled)

3. The method according to claim 1, wherein the amount of the soy protein is 10 to 36 wt. %, based on the total weight of the mixture.

4. The method according to claim 1, wherein the Chlorella is a powder obtained by drying a biomass obtained through culturing a Chlorella strain.

5. The method according to claim 4, wherein the Chlorella strain is Chlorella protothecoides, Chlorella vulgaris, Chlorella sorokiniana, or Chlorella pyrenoidosa.

6. The method according to claim 1, wherein the Chlorella is a powder obtained by drying a biomass obtained through culturing a chlorophyll-deficient Chlorella strain.

7. The method according to claim 6, wherein the chlorophyll-deficient Chlorella strain is a Chlorella protothecoides species.

8. (canceled)

9. The method according to claim 1, wherein the Chlorella is a powder obtained by drying a biomass obtained through culturing a Chlorella protothecoides strain, having a whiteness index (WI) of 70 or more as calculated from the following formula and a crude protein content of 55 wt % or more in the biomass.
$$WI = 10 \; 0 - \sqrt{{( 100 - L )}^{2} + {a}^{2} + {b}^{2}}$$
wherein, L, a, and b are Hunter L, a, and b values.

10. The method according to claim 9, wherein a crude protein content in the biomass is 55 to 80 wt. %.

11. The method according to claim 9, wherein a chlorophyll content in the biomass is 3.0 or less mg/g dry cell wight.

12. The method according to claim 9, wherein a chlorophyll content in the biomass is 0.1 to 3.0 mg/g dry cell wight.

13. The method according to claim 9, wherein the strain is Chlorella protothecoides DS-NCRC7W (KCTC 15163BP).

14. The method according to claim 1, wherein the Chlorella comprises a microalgae protein of 45 wt. % or more based on dry weight.

15. The method according to claim 1, wherein the Chlorella has a lipid content of 30 wt. % or less based on dry weight.

16. The method according to claim 1, wherein the amount of the Chlorella is 0.1 to 31 wt. %, based on the total weight of the mixture.

17. The method according to claim 1, wherein the mixture further comprises 35 to 65 wt. % of water.

18. The method according to claim 1, wherein the mixture comprises 10 to 36 wt. % of soy protein, 0.1 to 31 wt. % of Chlorella, and 35 to 65 wt. % of water.

19. The method according to claim 1, wherein the mixture further comprises gluten, oil, or a mixture thereof.

20. The method according to claim 1, wherein the mixture further comprises 0 to 10 wt. % of gluten and 1 to 1.5 wt. % of oil.

21. The method according to claim 1, wherein the mixture comprises 10 to 36 wt. % of soy protein, 0.1 to 31 wt. % of Chlorella, 0 to 10 wt. % of gluten, 1 to 1.5 wt. % of oil, and 35 to 65 wt. % of water.

22. The method according to claim 1, wherein the extruding is carried out at an ejection temperature of 80 to 170° C. and a cooling temperature of 68 to 75° C., in a twin-screw extruder.
